(19) United States
(12) Patent Application Publication
(10) Pub. No.: US 2015/0065333 A1
(43) Pub. Date: Mar. 5, 2015

(54) BIFUNCTIONAL CATALYSTS FOR OXYGEN REDUCTION AND EVOLUTION REACTIONS AND RECHARGEABLE METAL AIR BATTERIES USING THE SAME

(71) Applicant: Agency for Science, Technology and Research, Singapore (SG)

(72) Inventors: Xiaoming Ge, Singapore (SG); Zhao Lin Liu, Singapore (SG); Fu Wei Thomas Goh, Singapore (SG); Yun Zong, Singapore (SG); Bing Li, Singapore (SG); Jie Zhang, Singapore (SG); T.S. Andy Hor, Singapore (SG)

(21) Appl. No.: 14/474,485

(22) Filed: Sep. 2, 2014

(30) Foreign Application Priority Data
Sep. 2, 2013 (SG) 201306603-0

(51) Int. Cl. H01M 4/90; H01M 12/08; H01M 4/86

(52) U.S. Cl. CPC H01M 4/9016; H01M 4/8673; H01M 12/08
USPC 502/1; 423/263; 502/303; 502/182

(57) ABSTRACT

The present disclosure relates to a catalyst for a metal air battery or fuel cell comprising a mixed metal oxide consisting of at least one lanthanide element and at least two different transition metal elements. The catalyst may further comprise a conducting additive. The present disclosure further provides an air electrode, metal air battery or fuel cell comprising the disclosed catalyst, and methods for forming the disclosed catalyst.

### CLAIM OF PRIORITY

This application claims the benefit of priority of Singapore Patent Application Serial No. 201306603-0, entitled “BIFUNCTIONAL CATALYSTS FOR OXYGEN REDUCTION AND EVOLUTION REACTIONS AND RECHARGEABLE METAL AIR BATTERIES USING THE SAME,” filed on Sep. 2, 2013, the benefit of priority of which is claimed hereby, and which is incorporated by reference herein in its entirety.

### TECHNICAL FIELD

The present invention generally relates to catalysts for metal air batteries and fuel cells and methods for making the same. The present invention also relates to the use of the catalyst in air electrodes, metal air batteries and fuel cells.

### BACKGROUND

Metal air batteries and alkaline fuel cells are environmentally friendly sources of energy that are viable alternatives to fossil fuels. Consequently, they are highly desirable in the application of electric vehicles and large-scale energy storage systems.

Both metal air batteries and alkaline fuel cells make use of an air permeable but liquid impermeable electrode assembly known as an air cathode. The development of the air cathode requires a delicate control of its porosity, hydrophobicity, electrical conductivity, and most importantly, choice of catalyst.

During battery/fuel cell discharge, oxidation of metals like zinc, aluminium and lithium occurs on the anode and releases electrons that are transported via an external circuit to the air cathode, where an oxygen reduction reaction (ORR) occurs and converts the oxygen from air to hydroxide ions. Depletion of the metal fuel is inevitable in a primary metal air battery or fuel cell. As such, a continuous supply of metal is required for long term operation which will increase the operation cost. Thus, there is a need for rechargeable metal air batteries and fuel cells.

In many applications, it is desirable to use the same cathode to perform the reverse reaction, known as oxygen evolution reaction (OER). Introducing oxygen evolution on the cathode can mitigate the depletion of the metal fuel by allowing the regeneration of the metal on the anode. Cathodes that can be used for both the ORR and OER are known as bifunctional cathodes. In order to operate electrochemical cells at high efficiency, electrocatalysts may be used in the cathode to improve the kinetics for the ORR and OER. However, the catalysts required for these reactions typically contain expensive previous metals such as platinum to achieve high performance, which limits their widespread application and large scale implementation.

In addition, many of the non-noble metal catalysts show poor activity. Slow kinetics for the ORR and OER create a large overpotential, a drop in voltage before current can be drawn from the cell for discharge cycles, or an increase in the voltage required to generate oxygen for charging cycles. This overpotential reduces cell efficiency, and/or requires the use of higher catalyst loadings.

Furthermore, many of the catalysts show poor durability. The harsh chemical environment of cells (strong acid or strong base electrolytes) can cause catalyst corrosion through oxidation and/or dissolution of metals. In addition, voltage cycling experienced during charging and discharging induces migration of metal particles into the electrolyte.

As such, there is a need to provide catalysts that overcome, or at least ameliorate, one or more of the disadvantages described above.

### SUMMARY

In a first aspect, there is provided a catalyst for a metal air battery or fuel cell comprising a mixed metal oxide consisting of at least one lanthanide element and at least two different transition metal elements.

The catalyst may be bifunctional such that it may be used in a cathode to improve the kinetics for the ORR and OER. Due to the bifunctional nature of the catalyst, the depletion of the metal after prolonged usage may be circumvented by the regeneration of the metal. In addition, the use of expensive precious metals such as platinum to achieve high performance may be avoided. Due to the use of elements that are more commonly available than platinum, the cost of the catalyst may be at least ten times lower than a catalyst that contains platinum. This may lead to the widespread application of the catalyst in industries that produce electric vehicles and large-scale energy storage systems.

The catalyst may have a significantly greater OER performance and comparable ORR performance to a platinum-based catalyst. Furthermore, the catalyst may show little degradation after prolonged periods of time compared to a platinum-based catalyst, thus demonstrating good stability and durability.

Due to the low conductivity of the catalyst, the catalyst performance may be improved by incorporating additives. The catalyst may additionally comprise a conducting additive that may increase the electrical conductivity of the catalyst in a synergistic manner due to strong coupling between the mixed metal oxide and conducting additive. While the mixed metal oxide catalyzes the ORR or OER, the conducting additive may provide an electronic percolation network for the electrons that are consumed or generated during ORR and OER respectively. In addition, the conducting additive may serve as the matrix where the catalyst may be anchored. Consequently, the resultant catalyst may perform even better than a catalyst without a conducting additive.

In a second aspect, there is provided an air electrode comprising the catalyst as described above.

In a third aspect, there is provided a metal air battery or fuel cell comprising a catalyst as described above. Advantageously, the metal air battery or fuel cell may be electrically rechargeable and have high capacity. In addition, the metal air battery disclosed herein may be able to perform continuously for long periods of time.

In a fourth aspect, there is provided a method for forming a catalyst for a metal air battery or fuel cell comprising a mixed metal oxide consisting of at least one lanthanide element and at least two different transition metal elements, comprising:

(i) mixing a solution containing a lanthanide element with a solution containing at least two different transition metal elements;

(ii) adjusting the pH of the solution from step (i) by adding an alkaline solution;

(iii) hydrothermally treating the mixture from step (ii) to form a precipitate from the solution;

(iv) separating the precipitate from the solution;

(v) drying the precipitate until complete dryness to form a precursor; and

(vi) calcinating the precursor to form the catalyst.

The step of calcination may lead to the formation of a single phase perovskite structure. An improved bifunctional catalytic activity with good stability and activity may be obtained due to the catalyst having a perovskite structure. Advantageously, the concentration of the metals in the solution may be varied to control the shape and morphology of the catalyst. The shape and morphology may be more uniform at lower concentrations of metals in the solution. Likewise, the pH of the solution from step (i), heating conditions in step (iii) and the calcination step may be used to control the shape and morphology of the catalyst.

In addition, the method may additionally comprise the step of adding a conducting additive after adjusting the pH of the solution. Advantageously, the method may produce catalysts with delicate morphology and structure control and intimate contact between the mixed metal oxide and the conducting additive.

In a fifth aspect, there is provided a method for forming a catalyst for a metal air battery or fuel cell comprising a mixed metal oxide consisting of at least one lanthanide element and at least two different transition metal elements, comprising:

(i) mixing a solution containing a lanthanide element with a solution containing at least two different transition metal elements;

(ii) heating the mixture from step (i) to obtain a gel;

(iii) heating the gel stepwise to form a baked gel;

(iv) grinding the baked gel to form a powder;

(v) calcinating the powder until complete dryness to form the catalyst.

In a sixth aspect, there is provided a method for forming a catalyst for a metal air battery or fuel cell comprising a mixed metal oxide catalyst and a conducting additive, comprising:

(i) mixing the catalyst as mentioned above with a conducting additive in an alcoholic medium to form a slurry;

(ii) drying the slurry to form a powder; and

(iii) grinding the powder.

### DEFINITIONS

The following words and terms used herein shall have the meaning indicated:

The term “catalyst” as used herein refers to a catalyst capable of catalyzing ORR and OER. In the context of this disclosure, the catalyst comprises a mixed metal oxide consisting of at least one lanthanide element and at least two different transition metal elements. In the context of this disclosure, the catalyst is free of an alkaline earth metal.

As used herein, the term “lanthanide element” refers to an element from the f-block lanthanide series.

As used herein, the term “transition metal element” refers to an element in the first row d-block of the Periodic Table and excluding the f-block lanthanide and actinide series.

The term “composite catalyst” as used herein refers to a catalyst capable of catalyzing ORR and OER, which further comprises a conducting additive. In the context of this disclosure, a conducting additive may increase the electrical conductivity of the catalyst in a synergistic manner.

The term “LCMO” as used herein refers to a catalyst containing lanthanum, cobalt, manganese and oxygen and in other words, a catalyst comprising an oxide of lanthanum, cobalt and manganese.

The terms “LCMO91”, “LCMO82”, “LCMO73” and “LCMO55” as used herein refers to LCMO synthesized from salt precursor solutions. The numbers imply the molar ratio of the cobalt to manganese, such that “LCMO91” refers to a Co:Mn ratio of 9:1, “LCMO82” refers to a Co:Mn ratio of 8:2, “LCMO73” refers to a Co:Mn ratio of 7:3 and “LCMO55” refers to a Co:Mn ratio of 5:5. As an example, when it is mentioned that LCMO82 has a molar concentration of 0.01 M, it indicates that the precursor salt solution contains 0.01 M of lanthanum, 0.008 M of cobalt and 0.002 M of manganese. In the context of this disclosure, the ratio of lanthanum to the sum of cobalt and manganese i.e. La:(Co+Mn) is 1:1.

The term “LCMO-C” as used herein refers to a composite catalyst comprising LCMO and carbon materials.

The term “LCMO-CNT” as used herein refers to a composite catalyst comprising LCMO and carbon nanotube (CNT).

The term “LCMO-CB” as used herein refers to a composite catalyst comprising LCMO and carbon black.

The term “LCMO-rGO” as used herein refers to a composite catalyst comprising LCMO and reduced doped/undoped graphene oxide (rGO).

The term “doped” as used herein refers to the addition of non-carbon elements to the carbon material.

The term “calcination” as used herein refers to a thermal treatment process in the presence of air or oxygen to bring about a thermal decomposition, phase transition, or removal of a volatile fraction from a material. Calcination reactions usually take place at or above the thermal decomposition temperature (for decomposition and volatilization reactions) or the transition temperature (for phase transitions) but at temperatures below the melting point of the product materials.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this specification, unless the context requires otherwise, the word “comprise”, or variations such as “comprises” or “comprising”, will be understood to imply the inclusion of a stated step or element or integer or group of steps or elements or integers, but not to the exclusion of any other step or element or integer or group of elements or integers. Thus, in the context of this specification, the term “comprising” means “including peripherally, but not necessarily solely”.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and sub-generic groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a catalyst will now be disclosed.

In a first aspect, there is provided a catalyst for a metal air battery or fuel cell comprising a mixed metal oxide consisting of at least one lanthanide element and at least two different transition metal elements.

The catalyst may be bifunctional such that it may be used in a cathode to improve the kinetics for the ORR and OER. Due to the bifunctional nature of the catalyst, the depletion of the metal after prolonged usage may be circumvented by the regeneration of the metal. In addition, the use of expensive precious metals such as platinum to achieve high performance may be avoided. The lanthanide element may be selected from the group consisting of lanthanum, cerium, praseodymium, neodymium, promethium, samarium, europium, gadolinium, terbium, dysprosium, holmium, erbium, thulium, ytterbium and lutetium. In a preferred embodiment, the lanthanide element is lanthanum.

The mixed metal oxide may comprise at least two different transition metal elements. The transition metal element may be selected from the group consisting of titanium, vanadium, chromium, manganese, iron, cobalt and nickel. In a preferred embodiment, the two different transition metal elements are cobalt and manganese. Due to the use of elements that are more commonly available than platinum, the cost of the catalyst may be at least ten times lower than a catalyst that contains platinum. This may lead to the widespread application of the catalyst in industries that produce electric vehicles and large-scale energy storage systems.

The mixed metal oxide may have the chemical formula La (M′, M″) O_{3-δ}, wherein La refers to a lanthanide element and M′ and M″ refer to two different transition metal elements and δ refers to undefined oxygen non-stoichiometry. This may lead to a bifunctional catalyst that is able to catalyze ORR and OER.

In a preferred embodiment, the mixed metal oxide is an oxide of lanthanum, cobalt and manganese. The range of δ may be selected from the group consisting of −0.3 to +0.3, −0.2 to +0.2 and −0.1 to +0.1. The perovskite structure may collapse if the oxygen non-stoichiometry is too high. Thus, the disclosed catalyst may have a range of δ mentioned above that allows maintenance of the perovskite structure. The ratio of M′:M″ may be 9:1, 8:2, 7:3, 6:4, 5:5, 4:6, 3:7, 2:8 or 1:9. The ratio of La:(M′+M″) may be 1:1. Advantageously, the disclosed catalyst may have a greater stability and/or activity when compared to the performance of an oxygen evolution catalyst and oxygen reduction catalyst when used separately on an equal mass basis. In addition, the catalyst may have a significantly greater OER performance and comparable ORR performance than a platinum-based catalyst. Furthermore, the catalyst may show little degradation after prolonged periods of time compared to a platinum-based catalyst, thus demonstrating good stability and durability.

The mixed metal oxide may have a structure selected from the group consisting of perovskite, pyrochlore, spinel, and Ruddlesden Popper phase structure, and a morphology selected from the group consisting of nanorod, nanodisc, nanofiber and nanoparticle. The structure of the mixed metal oxide is preferably perovskite, which may result in an improved bifunctional catalytic activity.

The range of the size of the mixed metal oxide may be selected from the group consisting of: about 1 nm to about 200 nm, about 5 nm to about 200 nm, about 10 nm to about 200 nm, about 20 nm to about 200 nm, about 30 nm to about 200 nm, about 40 nm to about 200 nm, about 50 nm to about 200 nm, about 60 nm to about 200 nm, about 70 nm to about 200 nm, about 80 nm to about 200 nm, about 90 nm to about 200 nm, about 100 nm to about 200 nm, about 1 nm to about 100 nm, about 10 nm to about 100 nm, about 10 nm to about 50 nm, and about 50 nm to about 150 nm.

Due to the low conductivity of the catalyst, the catalyst performance may be improved by incorporating additives. The catalyst may additionally comprise a conducting additive to increase the electrical conductivity of the catalyst in a synergistic manner due to strong coupling between the mixed metal oxide and conducting additive. While the mixed metal oxide catalyzes the ORR or OER, the conducting additive may provide an electronic percolation network for the electrons that are consumed or generated during ORR and OER respectively. In addition, the conducting additive may serve as the matrix where the bifunctional catalyst may be anchored. The conducting additive may be a carbon material selected from the group consisting of carbon nanotube, carbon nanofibers, spherical carbon structures such as fullerenes (“buckyballs”), carbon nanocone, carbon black and graphene oxide. The morphology of the carbon material may be selected from the group consisting of a particle, rod, wire, fibre and tube.

The carbon material may optionally be doped. The choice of dopant may be nitrogen, phosphorus, sulfur, fluorine or boron. In the case of a nitrogen-doped carbon material, the doping of the carbon material may cause different distances between the carbon-carbon adjacent elements and the carbon-nitrogen adjacent elements which may improve the catalytic activity of the catalyst. The incorporation of nitrogen may also improve the ORR activity of the carbon material through increasing the charge delocalization which enhances the ability of the nitrogen doped carbon material to bind oxygen molecules as compared to the undoped carbon material.

The catalyst may be used to make an air electrode that is bifunctional and exhibits excellent catalytic properties and stability for electrically rechargeable metal air batteries and fuel cells.

Exemplary, non-limiting embodiments of methods for forming a catalyst will now be disclosed. A method for forming a catalyst for a metal air battery or fuel cell comprising a mixed metal oxide consisting of at least one lanthanide element and at least two different transition metal elements, comprising:

(i) mixing a solution containing a lanthanide element with a solution containing at least two different transition metal elements;

(ii) adjusting the pH of the solution from step (i) by adding an alkaline solution;

(iii) hydrothermally treating the mixture from step (ii) to form a precipitate from the solution;

(iv) separating the precipitate from the solution;

(v) drying the precipitate until complete dryness to form a precursor; and

(vi) calcinating the precursor to form the catalyst.

Advantageously, the concentration of the mixed metal oxide in the solution may be varied to control the shape and morphology of the catalyst. The shape and morphology of the catalysts are characteristics that have a critical impact on the performance of the catalyst. The shape and morphology may be more uniform at lower concentrations of the mixed metal oxide in the solution. The concentration of the mixed metal oxide in the solution may be about 0.001 M to about 0.1 M. The concentration of the mixed metal oxide in the solution can be a value selected from the group consisting of: 0.001 M, 0.002 M, 0.005 M, 0.01 M, 0.015 M, 0.02 M, 0.025 M, 0.030 M, 0.035 M, 0.040 M, 0.045 M, 0.050 M, 0.055 M, 0.060 M, 0.065 M, 0.070 M, 0.075 M, 0.080 M, 0.085 M, 0.090 M, 0.095 M and 0.100 M.

The pH of the solution from step (i) may be varied to control the shape and morphology of the catalyst. The pH may be about 8.0, about 8.5, about 9.0, about 9.5, about 10.0, about 10.5, about 11.0, about 11.5, about 12.0, about 12.5, about 13.0, about 13.5 and about 14.0.

The hydrothermal treatment of the mixture may be carried out at a temperature of about 100° C. to 200° C. The temperature for heating the mixture can be a value selected from the group consisting of: 100° C., 110° C., 120° C., 130° C., 140° C., 150° C., 160° C., 170° C., 180° C., 190° C. and 200° C. The temperature at which the heating is carried out may control the shape and morphology of the catalyst.

The drying of the precipitate may be carried out at a temperature of about 50° C. to about 100° C. The temperature for drying the precipitate can be a value selected from the group consisting of: 50° C., 55° C., 60° C., 65° C., 70° C., 75° C., 80° C., 85° C., 90° C., 95° C. and 100° C. Alternatively, the precipitate may be freeze dried for about 1 day, about 2 days, about 3 days, about 4 days, about 5 days or about 6 days.

The step of calcination may lead to the formation of a single phase perovskite structure that results in an improved bifunctional catalytic activity. The calcination may be carried out at a temperature of about 700° C. to about 1000° C. The temperature for calcination can be a value selected from the group consisting of: 700° C., 710° C., 720° C., 730° C., 740° C., 750° C., 760° C., 770° C., 780° C., 790° C., 800° C., 810° C., 820° C., 830° C., 840° C., 850° C., 860° C., 870° C., 880° C., 890° C., 900° C., 910° C., 920° C., 930° C., 940° C., 950° C., 960° C., 970° C., 980° C., 990° C. and 1000° C.

The method may additionally comprise the step of adding a conducting additive after adjusting the pH of the solution.

Alternatively, another method for forming a catalyst for a metal air battery or fuel cell comprising a mixed metal oxide consisting of at least one lanthanide element and at least two different transition metal elements, comprising:
(i) mixing a solution containing a lanthanide element with a solution containing at least two different transition metal elements;
(ii) heating the mixture from step (i) to obtain a gel;
(iii) heating the gel stepwise to form a baked gel;
(iv) grinding the baked gel to form a powder;
(v) calcinating the powder until complete dryness to form the catalyst.

The heating of the mixture from step (i) may be carried out at a temperature of about 60° C. to about 90° C. The temperature for heating the mixture can be a value selected from the group consisting of: 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C. and 90° C. The temperature at which the heating is carried out may control the shape and morphology of the catalyst.

The stepwise heating of the gel may be carried out at a temperature of about 100° C., about 110° C., about 120° C., about 130° C., about 140° C. or about 150° C., followed by a temperature of about 250° C., about 260° C., about 270° C., about 280° C., about 290° C., about 300° C., about 310° C., about 320° C., about 330° C., about 340° C., or about 350° C. Heating of the gel at an initial temperature of about 100° C. to about 150° C. may advantageously drive off crystalline water and high-vapour pressure species. Subsequently, heating of the gel at about 250° C. to about 350° C. may convert hydrocarbon groups and ligands into carbon. If directly heated to more than 300° C., the gel may slightly explode, thereby negatively affecting the shape and morphology of the catalyst. As such, stepwise heating of the gel is preferred.

The calcination of the powder may be carried out at a temperature of about 600° C. to about 1000° C. The temperature for calcination can be a value selected from the group consisting of: 600° C., 610° C., 620° C., 630° C., 640° C., 650° C., 660° C., 670° C., 680° C., 690° C., 700° C., 710° C., 720° C., 730° C., 740° C., 750° C., 760° C., 770° C., 780° C., 790° C., 800° C., 810° C., 820° C., 830° C., 840° C., 850° C., 860° C., 870° C., 880° C., 890° C., 900° C., 910° C., 920° C., 930° C., 940° C., 950° C., 960° C., 970° C., 980° C., 990° C. and 1000° C. The temperature at which calcination is carried out may affect the structure of the catalyst. Advantageously, a single phase perovskite structure may be formed, which results in an improved bifunctional catalytic activity.

Alternatively, another method for forming a catalyst for a metal air battery or fuel cell comprising a mixed metal oxide and a conducting additive, comprising:
(i) mixing the catalyst described above with a conducting additive in an alcoholic medium to form a slurry;
(ii) drying the slurry to form a powder; and
(iii) grinding the powder.

The grinding of the powder results in a fine powder, which may be more easily processed during fabrication of the air cathode.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 shows transmission electron microscopy (TEM) images of the LCMO82 precursors synthesized via a hydrothermal method with varying pH value of the precursor solution.

FIG. 2 shows the thermogravimetric curve of the LCMO73 precursor synthesized via a hydrothermal method. The temperature ramping rate used was 20° C./min.

FIG. 3 shows the effect of heating the hydrothermal synthesized LCMO82 at different temperatures: as-synthesized precursor (a), calcined for 1 hour at temperatures of 400° C. (b), 500° C. (c), 600° C. (d), 700° C. (e), 800° C. (f) and 900° C. (g), respectively.

FIG. 4 shows X-ray diffraction (XRD) patterns of hydrothermally synthesized LCMO82: (a) as-synthesized precursor, (b) calcined at 600° C. for 1 hour, and (c) calcined at 700° C. for 1 hour.

FIG. 5 shows box plots of the atomic percentages of La, Co and Mn in LCMO82 perovskite. The LCMO82 perovskite was calcined at 700° C. for 1 hour.

FIG. 6 shows the ORR (a) and OER (b) polarization curves of LC, LCMO91, LCMO82, LCMO73 and LM prepared via a hydrothermal method.

FIG. 7 shows the ORR (a) and OER (b) polarization curves after heating the hydrothermal synthesized LCMO82 at different temperatures for 1 hour.

FIG. 8 shows the ORR (a) and OER (b) polarization curves of LCMO82 perovskite which was calcined at 700° C. for 1 hour.

FIG. 9 shows the ORR (a) and OER (b) polarization curves of LCMO82-CNT (20 wt. %) bifunctional catalyst at different rotation rates.

FIG. 10 shows the ORR (a) and OER (b) activity of LCMO82, LCMO82-CNT (20 wt. %), CNT, Pt/C and MnO₂ catalysts.

FIG. 11 shows the cyclic voltammogram of Pt/C (a) and LCMO82-CNT (20 wt. %) (b) in O₂ saturated 0.1 M aqueous KOH solution.

FIG. 12 shows the cyclic voltammogram of LCMO82-CNT (20 wt. %) in O₂ saturated 0.1 M aqueous KOH solution.

FIG. 13 is a schematic illustration of a zinc-air battery prototype (a) ambient air, (b) air electrode, (c) electrolyte, (d) zinc sheet and (e) borosilicate.

FIG. 14 shows the long-term discharge behavior of a zinc-air battery prototype at a discharge rate of 5.6 mA/cm² and with a discharge capacity of 1000 mAh.

FIG. 15 shows the cycling stability of a zinc-air battery prototype at charge/discharge rates of 5.6 mA/cm² and with a discharge and charge capacity of 30 mAh per cycle.

FIG. 16 shows the deep discharge/charge behavior of a zinc-air battery prototype at discharge rates of 5.6 mA/cm² and with a discharge and charge capacity of 240 mAh per cycle.

FIG. 17 shows the discharge-charge behavior of a zinc-air battery prototype at a discharge rate of 10 mA/cm² for 4 hours and a charge rate at 10 mA/cm² for 4 hours. The catalyst layer consists of LCMO-NrGO, Vulcan XC-72 carbon black and Nafion® 117 binder.

FIG. 18 shows the discharge-charge cycling behavior of a zinc-air battery prototype at a discharge rate of 2 mA/cm² for 4 hours and a charge rate at 1 mA/cm² for 8 hours. The catalyst layer consists of LCMO-NrGO, Vulcan XC-72 carbon black and Nafion® 117 binder.

### DETAILED DESCRIPTION OF DRAWINGS

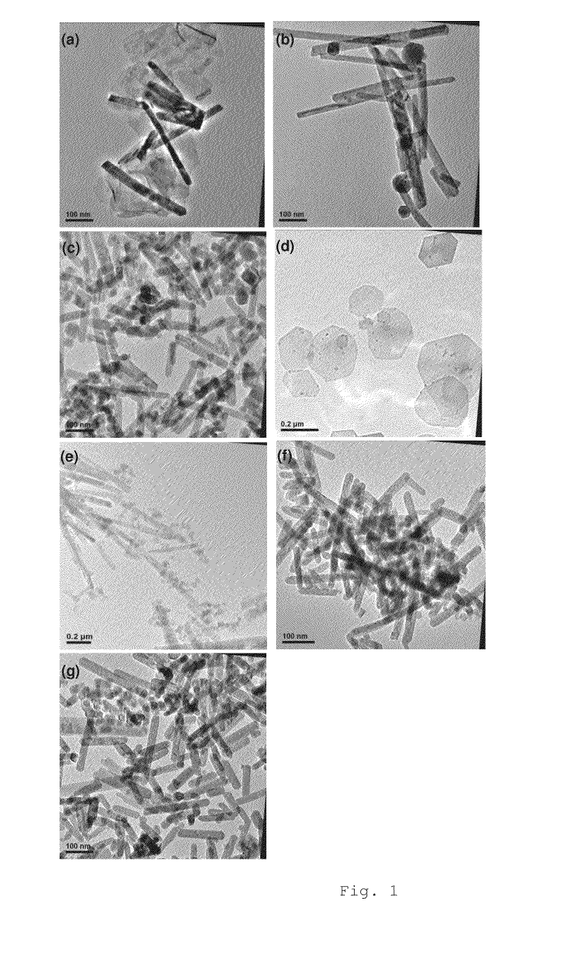

FIG. 1 shows transmission electron microscopy (TEM) images of the LCMO82 precursors synthesized via a hydrothermal method with varying pH value of the precursor solution. FIG. 1(a) to (d) show TEM images of LCMO82 formed using solutions of pH 10.8, 10.5, 10.0 and 9.0, respectively. In addition, the TEM images also show LCMO82 synthesized via a hydrothermal method with varying molar concentrations. FIG. 1(e) to (g) depict the TEM image of LCMO82 formed having a molar concentration of 0.065 M, 0.01 M, and 0.005 M, respectively.

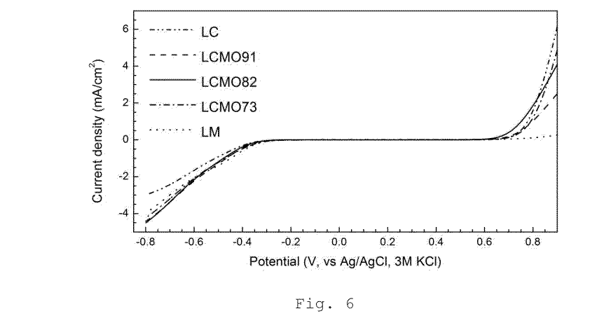

FIG. 6 shows the ORR (a) and OER (b) polarization curves of LC, LCMO91, LCMO82, LCMO73 and LM prepared via a hydrothermal method. The electrolyte used was O₂ saturated 0.1 M aqueous KOH solution. The rotating speed used was 2000 rpm and the potential was swept from +0.9 V to −0.8 V vs Ag/AgCl.

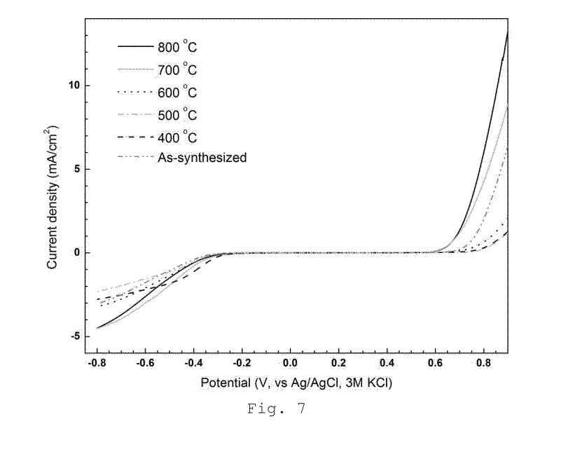

FIG. 7 shows the ORR (a) and OER (b) polarization curves after heating the hydrothermal synthesized LCMO82 at different temperatures for 1 hour. The electrolyte used was O₂ saturated 0.1 M aqueous KOH solution. The rotating speed used was 2000 rpm and the potential was swept from +0.9 V to −0.8 V vs Ag/AgCl.

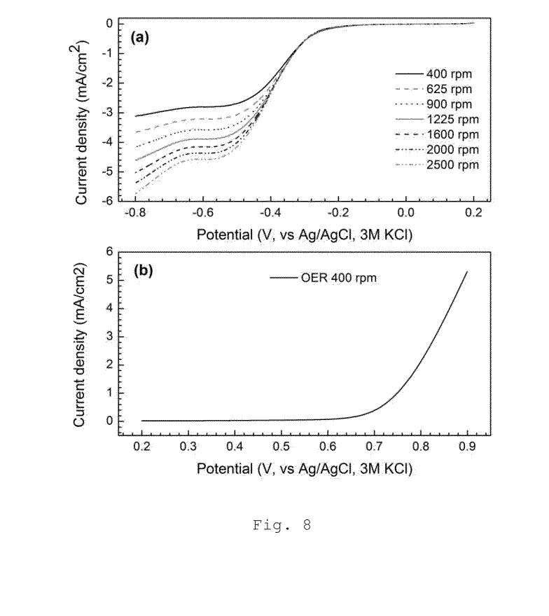

FIG. 8 shows the ORR (a) and OER (b) polarization curves of LCMO82 perovskite which was calcined at 700° C. for 1 hour. The electrolyte used was O₂ saturated 0.1 M aqueous KOH solution. The rotating speed used was 2000 rpm and the potential was swept from +0.2 V to −0.8 V vs Ag/AgCl. The LCMO82 was freeze dried for three days prior to calcination. As ORR is rotating rate-dependent, some fundamental reaction parameters, such as electron transfer numbers, may be obtained from a batch of ORR curves with various rotating rates. On the other hand, OER is independent of rotating rate. Thus, only one OER polarization curve (at 400 rpm) was reproduced herein.

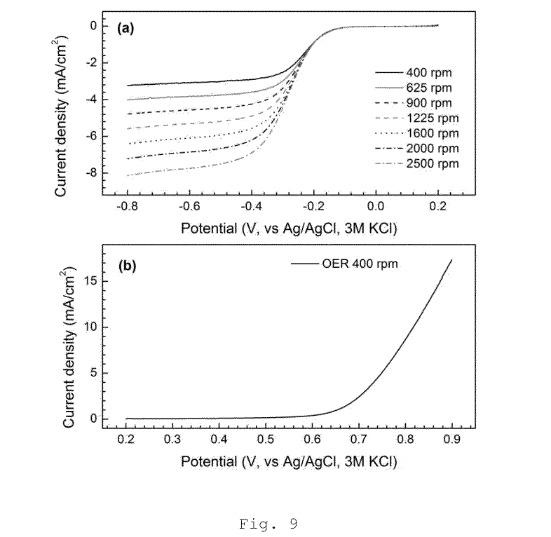

FIG. 9 shows the ORR (a) and OER (b) polarization curves of LCMO82-CNT (20 wt. %) bifunctional catalyst at different rotation rates, where the LCMO82 perovskite was calcined at 700° C. for 1 hour. The electrolyte used was O₂ saturated 0.1 M aqueous KOH solution. The rotating speed used was 2000 rpm and the potential was swept from +0.2 V to −0.8 V vs Ag/AgCl. The LCMO82 was freeze dried for three days prior to calcination. As ORR is rotating rate-dependent, some fundamental reaction parameters, such as electron transfer numbers, may be obtained from a batch of ORR curves with various rotating rates. On the other hand, OER is independent of rotating rate. Thus, only one OER polarization curve (at 400 rpm) was reproduced herein.

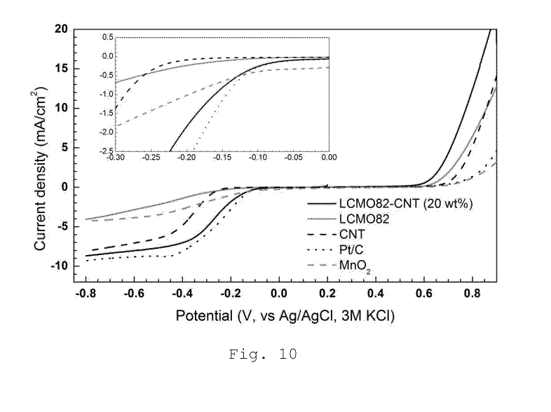

FIG. 10 shows the ORR (a) and OER (b) activity of LCMO82, LCMO82-CNT (20 wt. %), CNT, Pt/C and MnO₂ catalysts under the rotating speed of 2000 rpm. The LCMO82 was calcined at 700° C. for 1 hour and the MnO₂ nanorods were synthesized via a hydrothermal method using KMnO₄ and HCl. The electrolyte used was O₂ saturated 0.1 M aqueous KOH solution. The potential was swept from +0.9 V to −0.8 V vs Ag/AgCl.

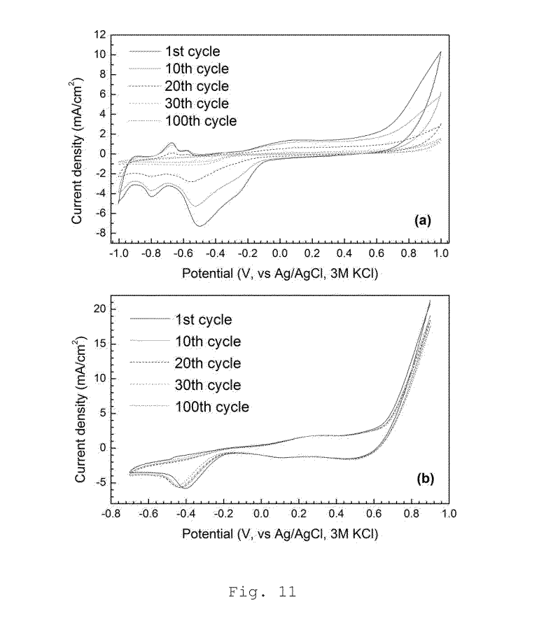

FIG. 11 shows the cyclic voltammogram of Pt/C (a) and LCMO82-CNT (20 wt. %) (b) in O₂ saturated 0.1 M aqueous KOH solution. The LCMO82 in LCMO82-CNT was used both as-synthesized and with heat treatment.

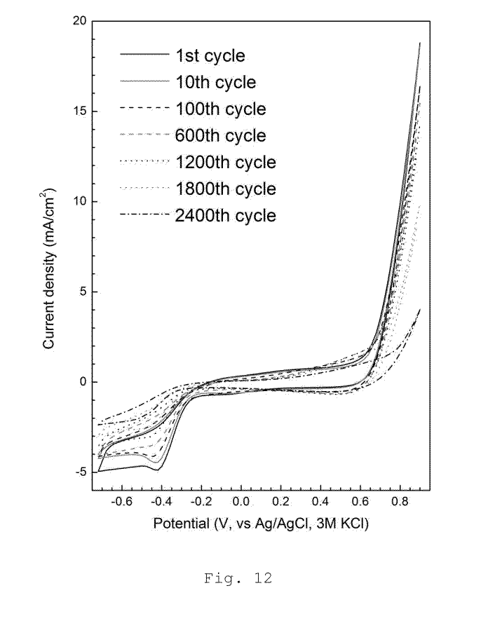

FIG. 12 shows the cyclic voltammogram of LCMO82-CNT (20 wt. %) in O₂ saturated 0.1 M aqueous KOH solution. The LCMO82 in LCMO82-CNT was calcined at 700° C. for 1 hour. The rotation rate was 400 rpm.

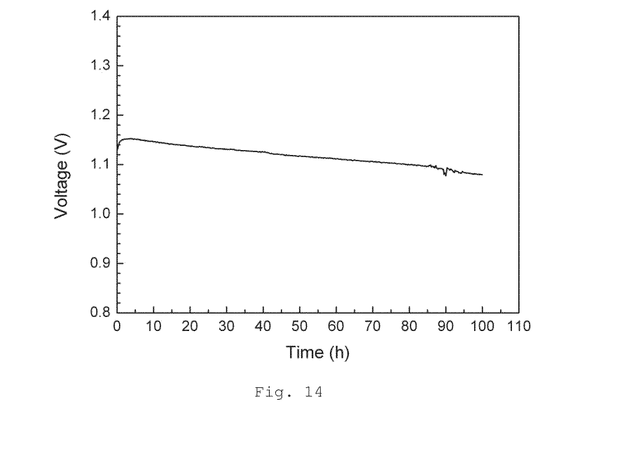

FIG. 14 shows the long-term discharge behavior of a zinc-air battery prototype at a discharge rate of 5.6 mA/cm² and with a discharge capacity of 1000 mAh. The bifunctional catalyst used was LCMO82-CNT (20 wt. %), and the LCMO82 precursor was dried in an oven overnight at 60° C. The LCMO82 perovskite was obtained by calcination at 900° C. for 1 hour. The electrolyte used was 6M aqueous KOH solution. It was shown that initial activation was visible, when the discharge voltage was increased from 1.12 V to 1.15 V. The battery cell was discharged satisfactorily for 100 hours with a voltage degradation rate of 0.3 mV/h or 0.02%/h.

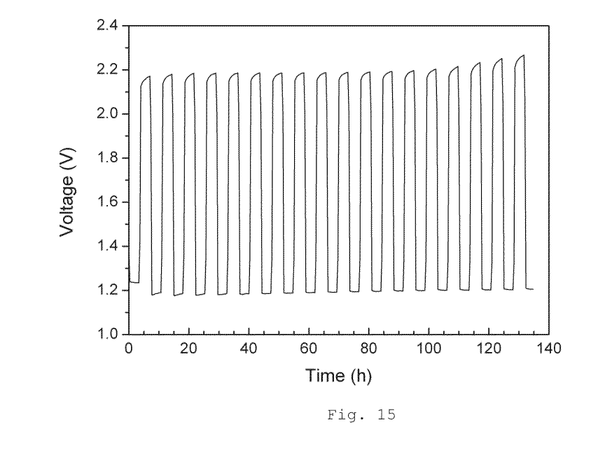

FIG. 15 shows the discharge-charge cycling stability of a zinc-air battery prototype at charge/discharge rates of 5.6 mA/cm² and with a discharge/charge capacity of 30 mAh per cycle. The bifunctional catalyst used was LCMO82-CNT (20 wt. %), and the LCMO82 precursor was freeze dried for three days. The LCMO82 perovskite was obtained by calcination at 900° C. for 1 hour. The electrolyte used was 6M aqueous KOH solution. The battery cell behaved consistently after a start-up period. Negligible degradation of the discharging voltage was observed for 20 cycles. In addition, the charging voltage was observed to increase from 2.17 V to 2.26 V, equivalent to a charging degradation rate 0.7 mV/h or 0.04%/h.

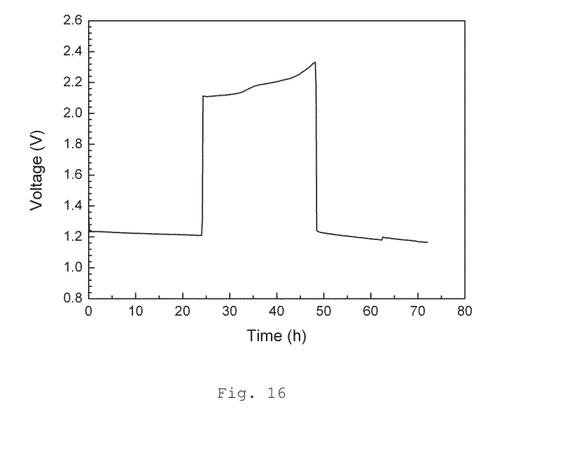

FIG. 16 shows deep discharge/charge behavior of a zinc-air battery prototype at discharge rates of 5.6 mA/cm² and with a discharge and charge capacity of 240 mAh per cycle. The bifunctional catalyst used was LCMO82-CNT (20 wt. %), and the LCMO82 precursor was dried in an oven overnight at 60° C. The LCMO82 perovskite was obtained by the calcination at 900° C. for 1 hour. The electrolyte used was a 6M aqueous KOH solution.

### EXAMPLES

Non-limiting examples of the invention and a comparative example will be further described in greater detail by reference to specific Examples, which should not be construed as in any way limiting the scope of the invention.

### Materials Used for all the Examples

Lanthanum nitrate hexahydrate, cobalt nitrate hexahydrate, manganese nitrate hydrate, citric acid monohydrate, N-methyl-2-pyrrolidone (NMP), polytetrafluoroethylene (PTFE), carbon nanotubes (CNT), ethanol and Nafion® 117 solution were purchased from Sigma-Aldrich (Minnesota, USA). Commercial carbon paper was purchased from SGL Carbon (Wiesbaden, Germany). Pt/C (30 wt. % Pt loaded on carbon black) was purchased from E-Tek (USA), polyvinylidene (Kynar® PVdF) was purchased from Arkema (USA) and potassium permanganate was purchased from GCE.

### Example 1

### Synthesis of Catalyst

The synthesis of the catalyst was exemplified by the synthesis of LCMO. There are two methods that may be used, namely a hydrothermal method and a sol-gel method.

LCMO91 synthesized using a hydrothermal method will now be disclosed. 0.35 mmol lanthanum nitrate hexahydrate, 0.315 mmol cobalt nitrate hexahydrate and 0.035 mmol manganese nitrate hydrate were dissolved in 70 mL water. The pH of the solution was then adjusted to 10.5 by dropwise addition of aqueous ammonium hydroxide, transferred to a Teflon-lined autoclave (Parr Instrument) and heated at 160° C. for 24 hours to form a precursor. After the autoclave was slowly cooled to room temperature, the precursor was separated from the solution via centrifugal method by washing with de-ionized water and ethanol five times. The precursor was freeze dried for three days or alternatively, dried in an oven overnight at 60° C. The dried precursor was then calcined above 600° C. to obtain LCMO perovskite structure.

The morphology and structure of LCMO may be controlled by controlling the heating conditions. For instance, different crystalline phases were obtained when the precursor was subjected to heat treatment at a temperature ranging from 70° C. to 1000° C.

LCMO91 synthesized using a sol-gel synthesis will now be disclosed. 0.35 mmol lanthanum nitrate hexahydrate, 0.315 mmol cobalt nitrate hexahydrate, 0.035 mmol manganese nitrate hydrate and 0.7 mmol citric acid monohydrate were dissolved in 40 mL water. The solution was stirred continuously and heated at 75° C. until a viscous purple gel was obtained. The gel was subsequently baked stepwise at 110° C. for 6 hours, followed by 250° C. for 3 hours. The baked gel was then grinded in an agate mortar for 10 minutes and calcined at 900° C. to obtain the LCMO perovskite in ambient air.

LCMO having varying molar ratios of lanthanum, cobalt and manganese were synthesized, as demonstrated in Table 1. The molar ratio of lanthanum was always equal to the sum of the molar ratio of cobalt and manganese, while the molar ratios of cobalt and manganese were varied. It was advantageously found that a perovskite structure was formed when the molar ratio of lanthanum was almost equal to the sum of the molar ratio of cobalt and manganese. The perovskite structure is a very good crystalline structure that allows deliberate tuning of the molar ratio of cobalt to manganese. By varying the cobalt to manganese ratio, the redox couple of Co²⁺/Co³⁺/Co⁴⁺ and Mn³⁺/Mn⁴⁺ will be changed accordingly. It is believed that the transition metal sites in the perovskite structure are the reaction sites for ORR/OER.

It was found that the hydrothermal method led to the formation of smaller and more uniform nanoparticles than the sol-gel method, which led to better electrochemical performance.

TABLE 1
LCMO Catalysts Synthesized with Varying Molar Ratios
of La, Co and Mn

| Sample | La | Co | Mn |
|---|---|---|---|
| LC | 1.0 | 1.0 | 0.0 |
| LCMO91 | 1.0 | 0.9 | 0.1 |
| LCMO82 | 1.0 | 0.8 | 0.2 |
| LCMO73 | 1.0 | 0.7 | 0.3 |
| LCMO55 | 1.0 | 0.5 | 0.5 |
| LM | 1.0 | 0.0 | 1.0 |

### Example 2

### Synthesis of Composite Catalyst

The synthesis of the composite catalyst was exemplified by the synthesis of LCMO-CNT. There are two methods that may be used, namely a co-hydrothermal method and a mechanical mixing method.

LCMO91-CNT synthesized using a co-hydrothermal method will now be disclosed. 0.35 mmol lanthanum nitrate hexahydrate, 0.315 mmol cobalt nitrate hexahydrate and 0.035 mmol manganese nitrate hydrate were dissolved in 70 mL water. The pH of the solution was then adjusted to 10.5 by dropwise addition of aqueous ammonium hydroxide and transferred to a Teflon-lined autoclave (Parr Instrument). 0.0948 g carbon nanotube (CNT) was then dispersed into the solution to form a 20 wt. % CNT mixture and the resultant mixture was heated in an autoclave at 160° C. for 24 hours to form a precursor. Subsequently, the precursor was naturally cooled to room temperature, separated from the solution via centrifugal method by washing with de-ionized water and ethanol five times. The precursor was freeze dried for three days or alternatively, dried in an oven for 12 hours at 70° C. The dried precursor was then calcined from 70° C. to 900° C. under nitrogen to obtain various LCMO-CNT structures.

The co-hydrothermal method described above advantageously allowed the control of the structure and morphology of the synthesized LCMO-CNT using different pH and different temperatures for calcination.

LCMO-C synthesized using a mechanical mixing method will now be disclosed. LCMO was grinded with a carbon material in the forms of either CNT, conductive carbon black or doped/undoped rGO in ethanol. The weight ratio of LCMO to carbon material used was 4:1. The slurry was dried in an oven from 70° C. to 100° C. and the dried powders were further grinded to fine catalyst powders.

### Example 3

### Characterization of LCMO and LCMO-C

The morphology and surface structure of the LCMO and LCMO-C bifunctional catalysts were observed via scanning electron microscopy (SEM, JEOL JSM6700F) and transmission electron microscopy (TEM, Philips CM300). Energy-dispersive X-ray spectroscopy (EDX, INCA/Oxford Instruments) was used to measure the chemical composition of bifunctional catalysts. Thermogravimetric analysis (TGA, TA Instruments, Q500) was carried out to monitor the weight loss of bifunctional catalysts when heated from room temperature to 800° C. in air. X-ray diffraction (Bruker D8 GADDS) was used to characterize the crystalline structure.

The morphology and surface structure of the bifunctional catalysts were studied using SEM and TEM. These two spectroscopic methods confirmed the presence of a variety of nanostructures such as nanorods, nanodiscs, nanofibers and nanoparticles in the as-synthesized LCMO82 precursor, depending on the hydrothermal synthesis conditions used (FIG. 1). It was found that varying the pH had an effect on the shape of the resultant catalyst. As exemplified by LCMO82, disc-shaped, rod-shaped or fiber-shaped were obtained when the pH value was increased from 9.0 to 10.8 (FIG. 1a to 1d). Furthermore, as illustrated by rod-shaped LCMO82 nanostructures, the shape and morphology of the LCMO82 nanostructures became more uniform with reduced metal source concentrations (FIG. 1e to 1g). It was observed that the rod-shaped LCMO82 nanostructures were damaged when calcined at a temperature between 400 to 600° C., presumably due to the decomposition of La(OH)₃.

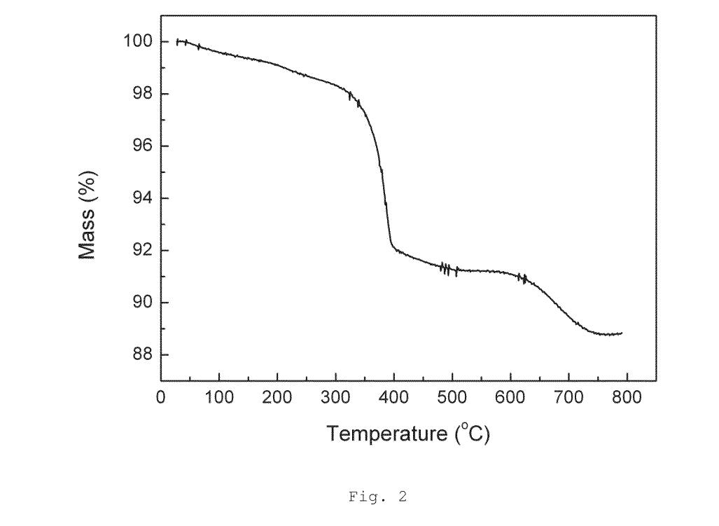

The weight loss of the bifunctional catalysts when heated from room temperature to 800° C. in air was monitored using thermogravimetric analysis (FIG. 2). As exemplified by LCMO73, a 6% weight loss was detected from 320° C. to 410° C. with the onset temperature of 365° C. This temperature range coincides with the decomposition temperature of La(OH)₃. As such, the weight loss observed was likely due to the decomposition of La(OH)₃. A gradual 2% weight loss was detected from 600° C. to 750° C., which may be due to the loss of lattice oxygen resulting from a change in phase structure.

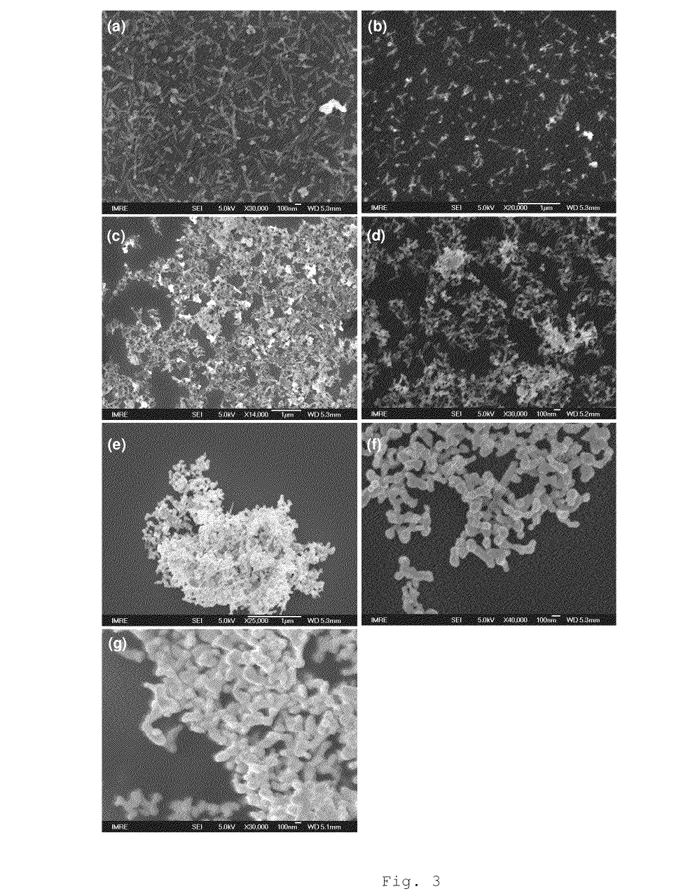

An investigation of the effect of calcination at different temperatures was also carried out using LCMO73 (FIG. 3). It was found that uniformly distributed nanoparticles started to form when the calcination temperature was in the range of 700° C. to 900° C.

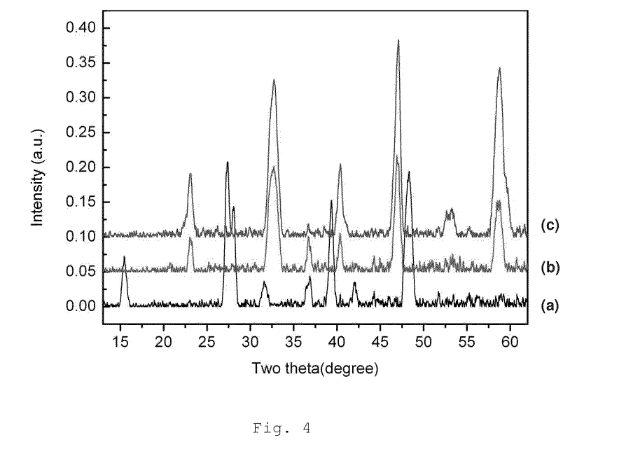

The crystalline structure of the bifunctional catalysts was analyzed using XRD and EDX. As exemplified by LCMO82, the XRD results showed a mixture of CoO, La(OH)₃ and Mn₃O₄ (FIG. 4). EDX analysis, combined with TEM results, further indicated that the nanorods were rich in La(OH)₃ and the nanoparticles were rich in CoO and Mn₃O₄. When calcined at 200° C. to 300° C., La(OH)₃ was retained and Co₃O₄ and (Co,Mn)₃O₄ were formed in the LCMO82. At higher temperatures, a variety of simple and complex oxide phases such as La₂O₃, Co₃O₄, Co₂Mn₃O₈ MnCo₂O_{4.5} and La₂CoO₄ started to evolve. A single phase perovskite structure started to form when the LCMO82 was calcined at a temperature above 600° C.

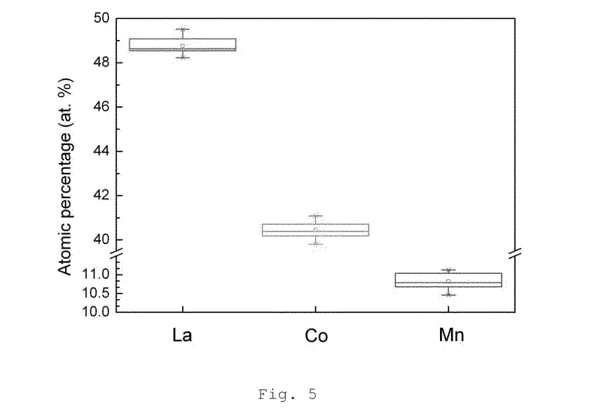

The composition of various LCMO was measured by EDX. FIG. 5 shows the box plots of the atomic percentages of La, Co and Mn, using LCMO82 perovskite as an example. The LCMO82 perovskite was obtained by calcination at 700° C. for 1 hour. Ten LCMO82 samples were measured in order to generate the box plots in FIG. 5. From the EDX results, the experimental atomic ratio of La:(Co+Mn) was determined to be 0.95, while the calculated stoichiometric ratio of La:(Co+Mn) was 1.00. The experimental atomic percentage of cobalt in LCMO82 was found to be 0.79, which is close to the calculated stoichiometric value of 0.80. In addition, the XRD results in FIG. 4 confirmed that the resultant LCMO82 had a perovskite structure. The perovskite structure, with a formula of ABO₃ for the stoichiometric compound, can accommodate considerable A-site and B-site deficiency. Combining the EDX and XRD results, the chemical formula of LCMO82 was found to be La_{0.95}(Co_{0.79}Mn_{0.21})O₃. The same method was applied to determine the chemical formula of the other LCMO catalysts obtained.

The electrocatalytic activity and stability of the LCMO-based bifunctional catalysts will now be illustrated in Examples 4 and 5.

### Example 4

### Rotating Disk Electrode (RDE) Results

The electrocatalytic activity and stability of the LCMO-based bifunctional catalysts were evaluated via rotating disk electrode (RDE) technique. The RDE test rig used consisted of an Autolab potentiostat (Model PGSTAT302N), an automatically controlled Autolab rotation speed controller and a three-electrode cell system. The working electrode, counter electrode and reference electrode of the cell were an Autolab glassy carbon electrode (inner diameter of 5 mm), an Autolab platinum sheet electrode and an Autolab Ag/AgCl electrode, respectively. 13 mg of the bifunctional catalyst was suspended in 0.6 mL isopropanol added with 0.6 μL of 5 wt. % Nafion® 117 solution. The mixture was thoroughly ultrasonicated and shaken until a homogenous catalyst ink was achieved. To prepare a catalyst loaded working electrode, 9.8 μL of the catalyst ink was dripped onto a pristine glassy carbon electrode and allowed to dry overnight under ambient conditions. The catalyst loading used was 1 mg/cm². Prior to the RDE experiment, an Autolab cylindrical glass cell with the three electrode configuration was filled with 0.1 M aqueous KOH solution, which was purged with 99.999% pure O₂ for 30 minutes. The bifunctional ORR and OER behavior was evaluated by a linear sweeping voltammetry which ran from +0.9 V to −0.8 V vs Ag/AgCl (3M KCl) at a potential ramping rate of 5 mV/s. The potential range for the separated ORR and OER were 0.2 V to −0.8 V and 0.2 V to 0.9 V, respectively, while the other operating parameters were identical to the bifunctional ORR and OER evaluation. The rotating speeds of the working electrode studied in this Example were 400, 625, 900, 1225, 1600, 2000 and 2500 rpm. The working electrode was rotated at 400 rpm during a cyclic voltammetry degradation test. Commercially available Pt/C catalyst (30 wt. % platinum on carbon) was also tested for a comparison.

FIG. 6 shows the ORR and OER polarization curves of as-synthesized LC, LCMO91, LCMO82, LCMO73 and LM prepared via a hydrothermal method. It was found that LM was almost OER inactive, while the ORR was still reasonable. LC was found to be both ORR and OER active, but the ORR onset potential was the most negative and the ORR current density was the smallest among all the catalysts used. Of all the LCMO compounds investigated, LCMO82 seemed to be the best with an OER onset potential about 50 mV more negative than LCMO91 and LCMO73. The three LCMO compounds were comparable in terms of ORR activity.

FIG. 7 shows the ORR and OER polarization curves of heating the hydrothermal synthesized LCMO82 at different temperatures for 1 hour. Calcination of the LCMO82 precursor at 400° C. to 500° C. resulted in poor ORR and OER performance. The poor catalytic performance could be related to the irregular morphology, as illustrated in FIGS. 2b and 2c, and multiphase crystalline structures, as shown in FIG. 4. The OER onset potential and oxygen evolution currents began to move to the negative direction when the LCMO82 was calcined above 600° C., and corresponded to the temperature at which the perovskite structure started to form, as shown in FIG. 4. The LCMO82 perovskite had a slightly more positive ORR onset potential and oxygen reduction currents. More interestingly, the OER onset potential of LCMO82 perovskite was 0.611 V vs Ag/AgCl, 99 mV and 128 mV more negative than as-synthesized LCMO82 and LCMO82 calcined below 500° C., respectively. As shown in FIG. 2, LCMO82 perovskite was made up of larger nanoparticles with an average diameter of 70 nm to 100 nm, compared to the as-synthesized LCMO82 nanorods that had an average diameter of 30 nm to 40 nm and an aspect ratio of 4 to 8. As such, the improved bifunctional catalytic activity of LCMO82 perovskite, as shown by the improved ORR and OER performance was unlikely due to the particle morphology, and likely due to the perovskite structure itself.

FIGS. 8 and 9 show the separated ORR and OER polarization curves of LCMO82 and LCMO82-CNT, respectively, where the LCMO82 perovskite was calcined at 700° C. for 1 hour. As shown in FIGS. 9 and 10, both the ORR and OER performance were improved significantly by the addition of 20 wt. % CNT to LCMO82. FIG. 10 shows the ORR and OER activity of LCMO82, LCMO82-CNT (20 wt. %), CNT, Pt/C and MnO₂ catalysts under the rotating speed of 2000 rpm. The LCMO82 was calcined at 700° C. for 1 hour. MnO₂ nanorods were synthesized from a hydrothermal method using KMnO₄ and HCl. In a typical synthesis, 4 mmol of KMnO₄ and 16 mmol of concentrated HCl were added to 80 mL water. The solution was subsequently hydrothermally treated at 140° C. for 12 hours in a 100 mL Teflon-lined stainless steel autoclave to give MnO₂ nanorods. Table 2 lists a comparison of ORR and OER activity of LCMO82, LCMO82-CNT and Pt/C. The OER onset potential of Pt/C was 0.67 V, 30 mV and 90 mV more positive than LCMO82 and LCMO82-CNT, respectively. The OER current density of Pt/C at +0.9 V vs. Ag/AgCl was only 4.49 mA/cm², which is equivalent to 84% and 26% of the value obtained with LCMO82 and LCMO82-CNT, respectively. As indicated in the inset of FIG. 10, the ORR onset potential of LCMO82-CNT was −0.10 V, which is almost identical to Pt/C. However, the limiting current density of LCMO82-CNT was 8% smaller than that of Pt/C.

TABLE 2
Comparison of ORR and OER activity of LCMO, LCMO-CNT
and Pt/C in terms of onset potential and current density.

| | ORR | | OER | |
|---|---|---|---|---|
| | Onset | j (mA/cm²) | Onset potential | j (mA/cm²) |
| | potential (V, vs | at −0.8 V, | (V, vs | at +0.9 V, |
| Sample | Ag/AgCl) | 2000 rpm | Ag/AgCl) | 400 rpm |
| LCMO | −0.21 | −5.34 | 0.64 | 5.29 |
| LCMO- | −0.10 | −8.53 | 0.58 | 17.4 |
| CNT | | | | |
| Pt/C | −0.10 | −9.30 | 0.67 | 4.49 |

Apart from the ORR and OER activity which are critical descriptors for bifunctional catalysts, the catalyst stability is also important for practical applications. As such, full range degradation test was carried out via a cyclic voltammetry (CV) method in O₂-saturated 0.1 M KOH aqueous solution to investigate the stability of the bifunctional catalysts compared to commercially available catalysts.

A control was carried out using commercial available Pt/C. After 10 cycles, it was observed that the oxygen adsorption peak around +0.08 V, oxygen evolution currents and oxygen reduction currents became less obvious (FIG. 11a). After 30 cycles, the peak completely disappeared and the oxygen evolution and oxygen reduction currents were significantly reduced. After 100 cycles, the Pt/C catalyst became essentially inactive. As such, serious performance degradation was observed with the Pt/C catalyst within 100 cycles. This may be due to particle agglomeration, dissolution, surface oxide formation or detachment from the carbon support due to corrosion/erosion.

In contrast, LCMO82-CNT showed little performance degradation (FIG. 11b). The oxygen reduction peak was only reduced by 8% after 100 cycles. Thus, relative to Pt/C, LCMO82-CNT is a durable and robust bifunctional catalyst.

Another full range degradation test of LCMO82-CNT was performed up to 2400 cycles (FIG. 12). It was observed that the ORR current was degraded to half, while the OER current dropped 25% after 1200 cycles. After 2400 cycles, the ORR current still retained 47% of the initial value, while the OER current was 21% over the initial value. This degradation may be due to the erosion of the Nafion binders and the detachment of the catalysts due the hydrodynamic centrifugal forces instead of catalyst passivation, noting that this degradation test was performed under a rotating speed of 400 rpm.

### Example 5

### Application of the Bifunctional Catalysts

### (a): Construction of Metal-Air Battery Prototype and Battery Test Procedures

LCMO-based catalysts were evaluated in a home-made zinc-air battery prototype. The air cathode was prepared by a doctor blade method. The LCMO-based catalyst (73 wt. %), carbon black (18 wt. %), Nafion® 117 binder (9 wt. %) and solvent were homogeneously mixed to form the “catalyst slurry”. The catalyst slurries used in the doctor blade coating process were either polyvinylidene fluoride (PVdF), N-Methyl-2-pyrrolidone (NMP) based or polytetrafluoroethylene (PTFE)-water based catalyst slurries.

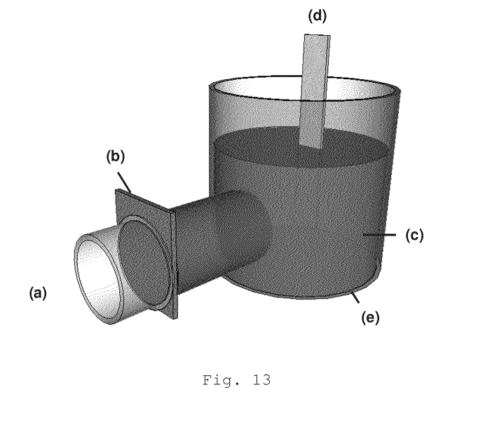

In the coating process, the catalyst slurry was applied onto a commercially available carbon paper by using a home-made doctor blade. The coated carbon paper was dried at 90° C. for 10 minutes for PVdF-NMP based slurry and at 80° C. for 20 minutes for PTFE-water based slurry. The coating process was repeated for 2 to 4 times, depending on the viscosity of the catalyst slurry, until no open pores were left on the carbon paper. The as-prepared air cathode was cut into small pieces of 3 cm×3 cm in dimension. The catalyst loading of the LCMO-based catalysts in the air cathode was 0.73 mg/cm². A zinc sheet having a thickness of 0.4 mm was cleaned and activated by soaking in a 3 M aqueous H₂SO₄ solution. An air cathode and a zinc sheet were assembled into a home-made borosilicate glass cell (FIG. 13). The air cathode was connected to the glass cell with a stainless steel clamp and exposed to ambient air, as shown in FIG. 13. The exposed area of the air cathode was 1.8 cm² and the electrolyte used was 25 mL of 6 M aqueous KOH solution. The distance between the anode and cathode was 30 cm and no separator was used.

Battery testing and cycling experiments were performed at 25° C. using the recurrent galvanic pulse method, where one cycle consisted of a discharging step (5.6 mA/cm² for several hours), followed by a charging step of the same current and duration time. These experiments were carried out via a Model 4300 battery tester. A cycling experiment was performed by cycling the charge-discharge procedure up to 30 cycles, depending on the charge/discharge capacity.

### (b): Metal-Air Battery Test Results

As illustrated in FIG. 16, the battery cell performed satisfactorily in the first discharge half-cycle, with a discharge voltage of 1.21-1.23 V and a degradation rate of 1.25 mV/h or 0.10%/h. However, the battery charging process was relatively sluggish and not so sustainable, reflected by a continuous charging voltage increase from 2.11 V to 2.34 V. The degradation rate of charging voltage was 9.5 mV/h or 0.45%/h. The poor charging behavior could be partly due to the large overpotential at the anode side. The zinc deposition in the anode was impeded due to the insufficient zinc source in the KOH electrolyte, as the zincate ions had a tendency to decompose into zinc oxide precipitate. In the second discharge half-cycle, the initial discharging voltage was still 1.23 V, but the degradation rate was doubled as compared to the values in the first one.

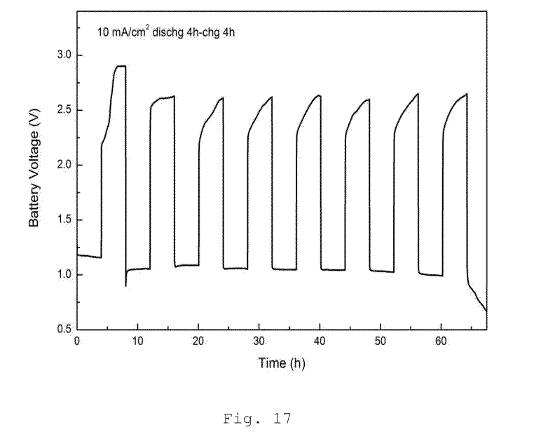

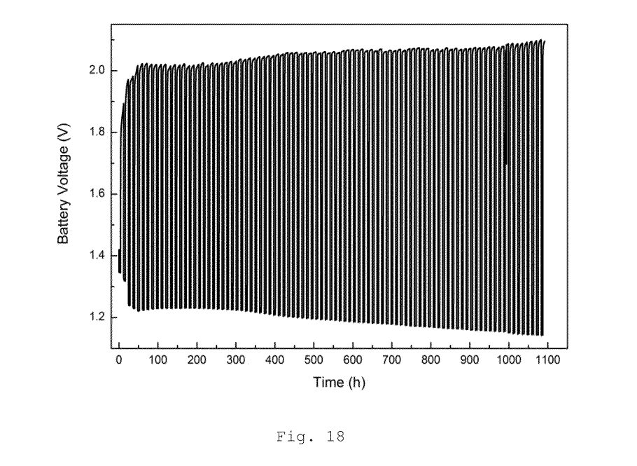

The battery test results illustrated by FIGS. 14 to 18 showed that LCMO-based zinc-air batteries are of high capacity and electrically rechargeable. It is particularly noteworthy that a zinc-air battery in which the catalyst layer consists of LCMO-NrGO, Vulcan XC-72 carbon black and Nafion® 117 binder showed an advantageously high rate and high stability, as illustrated by FIGS. 17 and 18.

### APPLICATIONS

The disclosed catalyst for a metal air battery or fuel cell is bifunctional and does not require the use of expensive precious metals such as platinum to achieve high performance. As such, the catalyst is suitable for widespread application and large scale implementation. In addition, the catalysts show good activity and stability even after prolonged use.

The disclosed catalyst may be applied to electrically rechargeable metal air batteries (zinc-air, aluminium-air and iron-air), alkaline fuel cells and oxygen electrolyzers. The metal air batteries and alkaline fuels containing the disclosed catalyst are environmentally friendly and can be used to power electric vehicles and serve as large-scale energy storage systems. In particular, zinc-air batteries containing the disclosed catalyst are of high capacity and electrically rechargeable.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

What is claimed is:

1. A catalyst for a metal air battery or fuel cell comprising a mixed metal oxide consisting of at least one lanthanide element and at least two different transition metal elements.

2. The catalyst according to claim 1, wherein the mixed metal oxide has the chemical formula La (M′, M″) O_{3-δ}.

3. The catalyst according to claim 1, wherein the lanthanide element is selected from the group consisting of lanthanum, cerium, praseodymium, neodymium, promethium, samarium, europium, gadolinium, terbium, dysprosium, holmium, erbium, thulium, ytterbium and lutetium.

4. The catalyst according to claim 1, wherein the transition metal element is selected from the group consisting of titanium, vanadium, chromium, manganese, iron, cobalt and nickel.

5. The catalyst according to claim 2, wherein M′ is cobalt and M″ is manganese.

6. The catalyst according to claim 2, wherein the ratio of M′:M″ is selected from the group consisting of 9:1, 8:2, 7:3, 6:4, 5:5, 4:6, 3:7, 2:8 and 1:9.

7. The catalyst according to claim 2, wherein the ratio of La:(M′+M″) is 1:1.

8. The catalyst according to claim 1, wherein the catalyst has a perovskite structure.

9. The catalyst according to claim 1, wherein the catalyst has the ability to catalyze oxygen reduction and evolution reactions.

10. The catalyst according to claim 1, additionally comprising a conducting additive.

11. The catalyst according to claim 9, wherein the conducting additive is a carbon material.

12. The catalyst according to claim 11, wherein the carbon material is selected from the group consisting of carbon nanotube, carbon black and graphene oxide.

13. An air electrode comprising a catalyst according to claim 1.

14. The air electrode according to claim 13, additionally comprising a conducting additive.

15. A metal air battery or fuel cell comprising a catalyst according to claim 1.

16. The metal air battery or fuel cell according to claim 14, additionally comprising a conducting additive.

17. A method for forming a catalyst for a metal air battery or fuel cell comprising a mixed metal oxide consisting of at least one lanthanide element and at least two different transition metal elements, comprising:
(i) mixing a solution containing a lanthanide element with a solution containing at least two different transition metal elements;
(ii) adjusting the pH of the solution from step (i) by adding an alkaline solution;
(iii) hydrothermally treating the mixture from step (ii) to form a precipitate from the solution;
(iv) separating the precipitate from the solution;
(v) drying the precipitate until complete dryness to form a precursor; and
(vi) calcinating the precursor to form the catalyst.

18. The method according to claim 17, wherein the hydrothermal treating is carried out at a temperature of 100° C. to 200° C.

19. The method according to claim 17, wherein the drying of the precipitate is carried out at a temperature of 50° C. to 100° C. or freeze dried for 3 days.

20. The method according to claim 17, wherein the calcination is performed in the temperature range of 700° C. to 1000° C.

21. The method according to claim 17, wherein calcination leads to formation of a catalyst having a perovskite structure.

22. The method according to claim 17, additionally comprising the step of adding a conducting additive after adjusting the pH of the solution.

23. A method for forming a catalyst for a metal air battery or fuel cell comprising a mixed metal oxide consisting of at least one lanthanide element and at least two different transition metal elements, comprising:
(i) mixing a solution containing a lanthanide element with a solution containing at least two different transition metal elements;
(ii) heating the mixture from step (i) to obtain a gel;
(iii) heating the gel stepwise to form a baked gel;
(iv) grinding the baked gel to form a powder; and
(v) calcinating the powder until complete dryness to form the catalyst.

24. The method according to claim 23, wherein the heating of the mixture from step (i) is carried out at a temperature of 60° C. to 90° C.

25. The method according to claim 23, wherein the heating is carried out at a temperature of 100° C. to 150° C. followed by a temperature of 250° C. to 350° C.

26. The method according to claim 23, wherein calcination of the powder is carried out at a temperature of 600° C. to 1000° C.

27. A method for forming a catalyst for a metal air battery or fuel cell comprising a mixed metal oxide catalyst and a conducting additive, comprising:
(i) mixing the catalyst of claim 1 with a conducting additive in an alcoholic medium to form a slurry;
(ii) drying the slurry to form a powder; and
(iii) grinding the powder.
